(19) United States
(12) Patent Application Publication
(10) Pub. No.: US 2003/0137084 A1
(43) Pub. Date: Jul. 24, 2003

(54) SiC Fiber-reinforced SiC-matrix composite and manufacturing method thereof

(75) Inventors: Akira Kohyama, Uji-shi (JP); Masaki Kotani, Uji-shi (JP); Yutai Katoh, Uji-shi (JP)

Correspondence Address: Russell D. Orkin., WEBB ZIESENHEIM LOGSDON ORKIN & HANSON, P.C., 700 Koppers Building, 436 Seventh Avenue, Pittsburgh, PA, 15219-1818, US

(73) Assignee: Japan Science and Technology Corporation, Kawaguchi-shi (JP)

(21) Appl. No.: 10/283,035

(22) Filed: Oct. 25, 2002

Related U.S. Application Data
(63) Continuation-in-part of application No. PCT/JP01/09360, filed on Oct. 25, 2001.
(63) Continuation-in-part of application No. PCT/JP01/09361, filed on Oct. 25, 2001.
(63) Continuation-in-part of application No. PCT/JP01/09362, filed on Oct. 25, 2001.

(30) Foreign Application Priority Data
Feb. 27, 2001 (JP) 2001-052147
Feb. 27, 2001 (JP) 2001-052148
Feb. 27, 2001 (JP) 2001-052149

(51) Int. Cl. C04B 35/565

(52) U.S. Cl. 264/625; 264/640; 501/95.2

(57) ABSTRACT

SiC fiber-reinforced SiC-matrix composite has the structure that SiC filaments are inserted into SiC matrix formed as a pyrolysis product of polyvinyl-silane (PVS) infiltrated into openings of said SiC filaments. PVS as a polymeric SiC precursor has structural units (a) and (b) at an a/b ratio of 1. A SiC fiber preform is impregnated with PVS slurry in an open or vacuum atmosphere, preheated at 300-400° C. in an inert gas atmosphere to moderate PVS to a viscous or semi-cured state, and then pyrolyzed in an argon atmosphere under application of a unidirectional pressure. A product is SiC fiber-reinforced SiC-matrix composite excellent in mechanical strength and high-temperature property with high density. The SiC composite is further densified by infiltration of PVS slurry suspending fine SiC particles therein or by repetition of impregnation with sole PVS and pressure-less pyrolysis after the pressurized pyrolysis.

(a)

—SiH₂—CH₂—CH₂—

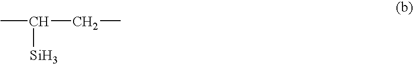

### BACKGROUND OF THE INVENTION

The present invention relates to SiC composite, which is useful as structural members of aircraft, spacecraft, nuclear reactors, nuclear fusion power reactors or the like exposed to a high-temperature atmosphere or neutron radiation, excellent in heat-resistance and irradiation resistance, and also relates to a manufacturing method thereof Various ceramics such as SiC and Si₃N₄, which are good of heat- and corrosion-resistance as well as mechanical strength, have been developed so far for structural members of aircraft, spacecraft, nuclear reactors or the like driven under severe conditions. Such ceramics are also used as members of heat exchangers or mechanical seals driven under heavy-duty conditions. Especially, SiC is a suitable material in various industrial fields from aerospace to nuclear power generation, due to good reduced-activation property in nuclear environment in addition to its excellent heat- and wear-resistance.

SiC is brittle itself, despite of good high-temperature property with a sublimation temperature higher than 2600° C. In order to overcome poor toughness, SiC composite reinforced with SiC fibers has been proposed, as disclosed in A. Lacombe and C. Bonnet, 2nd Int. Aerospace Planes Conf Proc. AIAA-90-5208(1990) and C. W. Hollenberg et al., J. Nucl. Mat., 219, (1995)70-86.

A representative method for production of fiber-reinforced SiC composite is a polymer impregnation and pyrolysis process, wherein a SiC fiber preform is impregnated with a polymeric SiC precursor, and then pyrolyzed to form a matrix. The polymer impregnation and pyrolysis process, which resembles a conventional FRP (fiber-reinforced plastics) manufacturing process in impregnation of a fiber preform with liquid material, is expected as a process suitable for production of complicated parts with high freedom on shape and size.

The polymer impregnation and pyrolysis process necessitates infiltration of a polymeric SiC precursor, which will form SiC matrix, to fine openings between filaments of a SiC fiber preform. In a conventional method using a polymeric SiC precursor solidus or viscous at an ambient temperature, the polymeric SiC precursor is conditioned to proper viscosity by melting with a heat or dilution with a solvent in prior to pyrolysis, in order to improve its infiltration into the SiC fiber preform. Such the SiC precursor shall be a polymer, which can be ceramized at a high yield ratio, in order to form a matrix of dense SiC composite.

In general, a polymer, which is fluid enough to infiltrate into openings between SiC filaments, has one-dimensional molecular structure of low molecular weight or with a small ratio of network structure. Formation of network structure may be accelerated during pyrolysis by introduction of an unsaturated hydrocarbon or hydroxyl group to side chains of the polymeric SiC precursor. However, introduction of an unsaturated hydrocarbon or hydroxyl group causes increase of surplus carbon and oxygen derived from pyrolysis and worsens properties of SiC composite.

The polymer having such a structure is somewhat discharged as gases without ceramization by application of a thermal energy to break intermolecular restraints. Gases partially remain as bubbles in the SiC fiber preform. Volumetric shrinkage also occurs during pyrolysis of the polymer. Increase of residual bubbles (in other words, increase of porosity), which impedes densification of SiC fiber-reinforced SiC-matrix composite, and volumetric shrinkage, which causes generation of many pores in SiC matrix, are unfavorable for improvement of toughness by insertion of SiC fiber as reinforcement. As a result, a pyrolyzed product does not fulfil required properties.

The fiber-reinforced SiC composite is densified by repetition of impregnation and pyrolysis so as to fill pores with a polymeric SiC precursor. But, pores are often plugged with the polymeric SiC precursor, when the polymeric SiC precursor is boiled up and cured at random. Once the pores are plugged, the polymeric SiC precursor does not infiltrate any more into pores between filaments or bundles. Consequently, densification of the SiC composite is insufficiently finished.

There is also another proposal for densification of SiC composite, wherein extrusion of polymeric slurry from a SiC fiber preform is suppressed by curing treatment such as oxidation with a heat or irradiation with electron beam, and then a polymer-impregnated fiber preform is pyrolyzed with a pressure. Pressurized pyrolysis for densification is advantageous in the polymer impregnation and pyrolysis process for manufacturing fiber-reinforced SiC-matrix composite useful as various parts, but such the curing treatment often worsens high-temperature property of the SiC composite and also needs expensive electron beam irradiating equipment or the like.

Polycarbosilane has been used so far as a polymeric SiC precursor. However, polycarbosilane is pyrolyzed to a product rigidly bonded to SiC filaments. Rigid bonding does not allow relative slipping motion between SiC filaments and SiC matrix essential for realization of toughening action.

Although interfacial property between SiC filaments and SiC matrix is controlled by provision of an interfacial layer such as C or BN on SiC filaments, manufacturing conditions shall be determined accounting environmental capability of the interfacial layer. In fact, when a polymer-impregnated SiC fiber preform is heated in presence of an interfacial layer such as C or BN at a boundary between SiC filaments and SiC matrix, C or BN is oxidized. The generated oxide is removed from the boundary or left as such, resulting in poor toughness of SiC composite.

### SUMMARY OF THE INVENTION

The present invention aims at provision of dense SiC fiber-reinforced SiC-matrix composite, which is good of fracture work without use of any solvent harmful to the environment. An object of the present invention is to manufacture SiC fiber-reinforced SiC-matrix composite by impregnating a SiC fiber preform with polyvinyl-silane (PVS), which is good of infiltration and well ceramized in prior to pyrolysis.

The present invention proposes new SiC-fiber reinforced SiC-matrix composite having the structure that SiC filaments as reinforcement are inserted into SiC matrix, which is a pyrolyzed product of PVS infiltrated into openings of a SiC fiber preform.

PVS has the under-mentioned structural units (a) and (b) with an a/b ratio of 1.

(a)

—SiH₂—CH₂—CH₂—

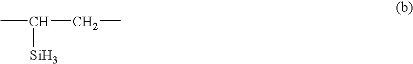

The SiC composite is manufactured by impregnating a SiC fiber preform with PVS slurry and then pyrolyzing the impregnated fiber preform at 100˜1300° C. in an argon atmosphere. PVS slurry is preferably moderated to a viscous or semi-cured state at 300-400° C. in an inert gas atmosphere in prior to the pyrolysis. Pyrolysis of the impregnated fiber preform is performed under application of a unidirectional pressure preferably of 2-10 MPa. After the pressurized pyrolysis, the SiC composite may be further subjected to alternate repetition of impregnation with sole PVS and pressure-less pyrolysis in order to improve density and strength of the SiC composite.

PVS slurry is not diluted with any solvent, since it is fluid enough for infiltration into openings between SiC filaments. Fluidity of PVS slurry is properly reduced by the preheat-treatment at 300-400° C. to a level to inhibit extrusion from the SiC fiber preform during pressurized pyrolysis. SiC particles of 0.1-1.0 μm in size are optionally dispersed in PVS slurry at a ratio of 25-70 mass %.

### BRIEF DESCRIPTION OF THE DRAWINGS

FIG. 1 is a chart showing an effect of mass fraction of SiC particles on density of a pyrolyzed body.

FIG. 2 is a chart showing an effect of mass fraction of SiC particles on flexural strength and fracture work of a pyrolyzed body.

### PREFERRED EMBODIMENTS OF THE INVENTION

PVS, which has the above-mentioned structural units (a), (b) with an a/b ratio of 1, is selected as a polymeric SiC precursor from silicon compounds having vinyl groups or synthesized by polymerization of vinyl compounds. The defined PVS is a substance, which is affinitive with SiC filaments but has molecular structure different from an original polymer for SiC filaments, well ceramized to the same composition at a yield ratio of 30-40 mass %. PVS mainly comprises one-dimensional molecular structure having side chains to which many Si-H bonds are added, with a liquid phase of low-viscosity (approximately 70 cP) at an ambient temperature.

PVS is a polymeric SiC precursor which continuously changes its viscosity in response to progress of pyrolysis, so that its cured state can be controlled by a heating temperature in an inert gas atmosphere. A heating temperature is properly predetermined from various experiments on relationship between a heating temperature and a cured degree, since it is difficult to directly measure a cured state of the polymeric slurry at a high temperature. PVS is still fluid at a heating temperature below 300° C. and mostly extruded out of a SiC fiber preform without remaining therein. PVS is excessively cured at a heating temperature above 400° C. on the contrary. Excessive curing causes occurrence of many cracks in the following pressurized pyrolyzing step without improvement of density. The SiC fiber preform is preferably held in contact with PVS with a pressure for 10 minutes or so.

Use of the defined PVS enables impregnation of a SiC fiber preform with polymeric slurry without necessity of dilution in a solvent, so as to form SiC matrix at a high yield ratio. Omission of a solvent is advantageous in densification of a product. If PVS diluted in a solvent is used for impregnation of the SiC fiber preform, a ratio of PVS consumed for impregnation is reduced, and a product is not densified so much. Omission of a solvent is also appropriate for manufacturing fiber-reinforced SiC composite at a low cost, since there is no necessity for processing of waste liquids, which are harmful to the environment.

Since the impregnated SiC fiber preform is pyrolyzed in absence of an interfacial layer such as C or BN at a boundary between SiC filaments and SiC matrix, intrinsic property, (e.g. excellent oxidation resistant) of SiC is realized in the pyrolyzed body. Omission of the interfacial layer is also advantageous for simplification of a manufacturing process.

PVS is also kept at good fluidity enough to infiltrate into openings between SiC filaments, even after dispersion of fine SiC particles at a high ratio in order to reduces volumetric shrinkage of SiC matrix. Reduction of volumetric shrinkage means densification of the pyrolyzed body.

When a mixture of PVS with fine SiC particles is pyrolyzed, larger volumetric shrinkage occurs under the condition that the polymer is fixed at a relative position, as compared with polycarbosilane. Such shrinkage causes formation of fine pores of several tens to several hundreds nm in size between SiC particles. As a result, a pyrolyzed body is improved in fracture toughness due to release of internal stress from its structure.

SiC particles to be dispersed in PVS is preferably of 0.3 μm or less in size. Particle size above 0.3 μm causes irregular distribution of SiC particles in a SiC fiber preform due to poor infiltration of PVS slurry into openings between SiC filaments. However, too fine SiC particles thickens PVS slurry to a level inappropriate for uniform distribution of SiC particles.

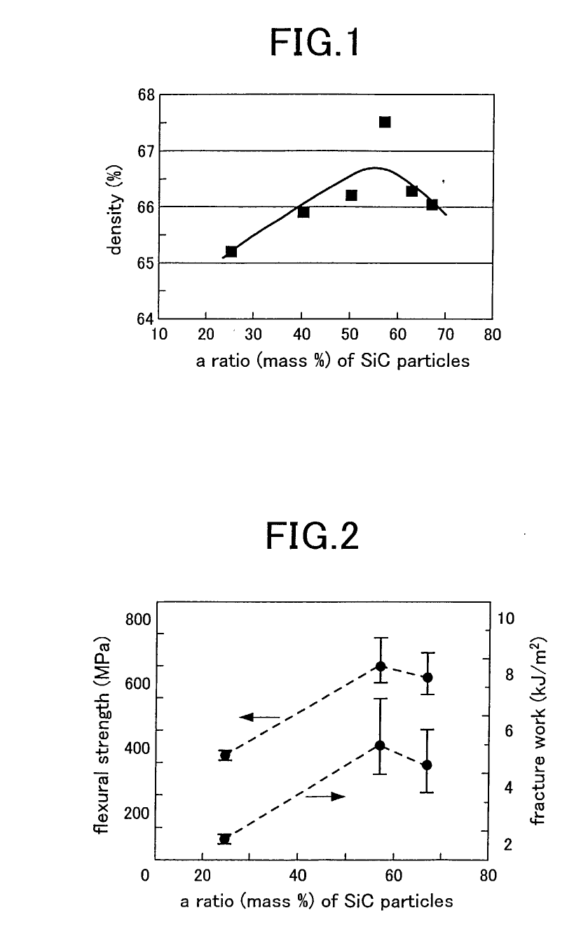

The effect of SiC particles on fracture toughness is noted by use of PVS slurry to which fine SiC particles are dispersed at a ratio of 25-70 mass %. If PVS slurry contains SiC particles less than 25 mass %, a pyrolyzed body is insufficiently strengthened without toughening action derived from slippage of SiC filaments from SiC matrix. Excessive addition of SiC particles more than 70 mass % on the contrary unfavorably increases viscosity of PVS slurry. Increase of viscosity impedes infiltration of PVS slurry into openings between SiC filaments, resulting in poor strength of a pyrolyzed product, as shown in FIGS. 1 and 2.

After a SiC fiber preform is impregnated with PVS slurry which optionally suspends fine SiC particles therein, the impregnated SiC fiber preform is pyrolyzed with a pressure. PVS is well ceramized to SiC as a matrix-forming material at a high yield ratio during pressurized pyrolysis. In prior to pressurized pyrolysis, PVS may be cured to viscosity effective for inhibiting extrusion of the polymeric SiC precursor from the SiC fiber preform during pressurized pyrolysis, since viscosity of PVS is gradually raised in response to its cured state. An effect of pressurized pyrolysis on properties (i.e. density, mechanical strength and heat-resistance) of SiC fiber-reinforced SiC-matrix composite is efficiently optimized by viscosity control of PVS.

Moderation of PVS slurry to a viscous or semi-cured state promotes densification of SiC composite during pressurized pyrolysis. Consequently, SiC fiber-reinforced SiC-matrix composite good of mechanical strength is produced. Especially, density and strength of the SiC composite are substantially influenced by a cured state of the polymeric SiC precursor in addition to pyrolyzing conditions. Therefore, the cured state and the pyrolysis conditions (i.e. a pressure and a temperature) are determined in response to required property of fiber-reinforced SiC composite.

Viscosity of PVS slurry is adjusted to a value suitable for suppressing its extrusion from a SiC fiber preform by preheat-treating PVS slurry to a viscous or semi-cured state at 300-400° C. PVS slurry preheat-treated at a temperature below 300° C. is still too fluid, so that its extrusion from the SiC fiber preform is not completely suppressed during pressurized pyrolysis. However, PVS is excessively cured to a non-plastic state by preheat-treatment at a temperature above 400° C. Such a non-plastic SiC precursor would be destroyed during pressurized pyrolysis. In this sense, it is preferable to hold a polymer-impregnated SiC fiber preform at 300-400° C. for 10 minutes or so.

The impregnated SiC fiber preform is preferably pyrolyzed at 1000-1300° C. in an argon atmosphere. If a pyrolysis temperature is below 1000° C., PVS is not completely ceramized due to insufficient pyrolysis. Incomplete ceramization means poor heat-resistance of fiber-reinforced SiC composite. If the impregnated SiC fiber preform is heated at a temperature higher than 1300° C. on the contrary, pyrolyzed products are excessively crystallized and grown up to coarse grains. Excessive growth of crystal grains causes occurrence of cracks and decrease in strength.

The impregnated SiC fiber preform is preferably pressed with 2-10 MPa during pyrolysis. An effect of pressure-application on hardening is typically noted at a pressure of 2 MPa or more. However, application of a pressure more than 10 MPa needs an expensive press and also causes significant damages on the SiC fiber preform.

A cured state of a preheat-treated polymeric SiC precursor together with a pressure applied to a SiC fiber preform during pyrolysis put substantial influences on density and strength of a pyrolyzed body. Therefore, a cured state of a preheat-treated polymeric SiC precursor and a pressure applied to a SiC fiber preform during pyrolysis are properly controlled in response to required property of the SiC fiber-reinforced SiC-matrix composite. Optimal conditions for pyrolysis of the impregnated SiC fiber preform are a heating temperature of 1200° C. and a pressure of 5 MPa, in general.

Argon is used as an atmospheric gas for pyrolysis of the impregnated SiC fiber preform, in order to inhibit production of SiO₂ which unfavorably reduces strength of the SiC composite. If the impregnated preform is pyrolyzed in an oxygen-containing atmosphere, Si-H bonds in PVS would be oxidized to SiO₂. If the impregnated preform is pyrolyzed in a nitrogen-containing atmosphere, nitrogen would be incorporated in PVS, resulting in generation of Si₃N₄. A vacuum atmosphere would put a large burden on a vacuum pump for discharging massive gasses during pyrolysis.

SiC fiber-reinforced SiC-matrix composite is further densified and improved in physical property by alternate repetition of impregnation with sole PVS and pressure-less pyrolysis after pressurized pyrolysis.

The other features of the present invention will be apparent from the following Examples.

### EXAMPLE 1

Continuous SiC filaments of 14 μm in average diameter were unidirectionally aligned to a sheet of 40 mm in length and 20 mm in width. 7 sheets were laminated to a SiC fiber preform with thickness of 2 mm. The SiC fiber preform was sealed in a carbon receptacle, and the carbon receptacle was set in an air-tight vessel. After the air-tight vessel was evacuated to vacuum degree lower than 1333 Pa, PVS of 10 ml was dropped to the SiC fiber preform little by little from an upper opening of the carbon receptacle. When boiling action of PVS was completely finished in the carbon receptacle, a polymer-impregnated SiC fiber preform was taken out together with the carbon receptacle from the air-tight vessel.

The polymer-impregnated SiC fiber preform was set in an argon atmosphere and heated up to 350° C. (623K) at a heating rate of 300° C./h. After the impregnated SiC fiber preform was held at 350° C. for 10 minutes, it was cooled down to an ambient temperature over one hour or longer. It is noted by observation of the impregnated SiC fiber preform that the infiltrating polymer was cured to a soft, elastic and yellowish solid and integrated with SiC filaments.

The impregnated SiC fiber preform was taken out from the carbon receptacle after the heat-treatment and then inserted in a carbon mold. Thereafter, the impregnated SiC fiber preform was heated up to 1200° C. at a heating rate of 300° C./h under application of a unidirectional pressure of 10 MPa along a perpendicular direction in an argon atmosphere in an oven equipped with a carbon heater. The impregnated SiC fiber preform was held at 1200° C. for 10 minutes and then gradually cooled in a state released from the pressure over 2 hours or longer. A product was SiC fiber-reinforced SiC-matrix composite with porosity of 40%.

The SiC composite was further impregnated with PVS in vacuum and then pyrolyzed without a pressure at a heating temperature up to 1200° C. The impregnation and the pressure-less pyrolysis were alternately repeated 6 times. The SiC composite subjected to the repetition of impregnation and pressure-less pyrolysis had flexural strength of 130 MPa or more in average and fracture work of 0.37 kJ/m² with porosity reduced to 22.6%, and its fracture mode was nonlinear.

### EXAMPLE 2

Continuous SiC filaments of 14 μm in diameter were unidirectionally aligned to a SiC fiber sheet of 40 mm in length and 20 mm in width. PVS slurry, to which β-SiC particles of 0.3 μm in average size were dispersed at a ratio of 25 mass %, was dropped on the SiC fiber sheet in an open atmosphere, to impregnate the SiC fiber sheet with PVS slurry. The impregnated SiC fiber sheet was heated up to 330° C. (603K) at a heating rate of 300° C./h, held at 330° C. for 10 minutes and then gradually cooled down to an ambient temperature over one hour or longer. It was noted by observation of the impregnated SiC fiber sheet that semi-cured PVS was integrated with SiC filaments.

14 of the impregnated SiC fiber sheets were laminated to a SiC fiber preform of 2 mm in thickness. The SiC fiber preform was inserted in a carbon mold, heated up to 1200° C. at a heating rate of 300° C./h under application of a unidirectional pressure of 5 MPa along a perpendicular direction in an argon atmosphere in an oven equipped with a carbon heater, held at 1200° C. for 10 minutes and then cooled in a pressure-released state over 2 hours or longer. A product was SiC fiber-reinforced SiC composite with porosity of 33%.

The SiC composite was further impregnated with PVS in vacuum and pyrolyzed without a pressure at a temperature not higher than 1200° C. The impregnation and the pressure-less pyrolysis were alternately repeated 6 times. The SiC composite subjected to the repetition of impregnation and pressure-less pyrolysis had flexural strength of 334 MPa in average and fracture work of 1.7 kJ/m² with porosity reduced to 12%.

### EXAMPLE 3

Continuous SiC filaments of 14 μm in diameter were unidirectionally aligned to a SiC fiber sheet of 40 mm in length and 20 mm in width. PVS slurry, to which β-SiC particles of 0.3 μm in average size were suspended at a ratio of 25 mass %, was dropped on the SiC fiber sheet in an open atmosphere to impregnate the SiC fiber sheet. The PVS-impregnated SiC fiber sheet was heated up to 350° C. at a heating rate of 300° C./h in an argon atmosphere, held at 350° C. for 10 minutes and then cooled down to an ambient temperature over one hour or longer. It was noted by observation of the impregnated SiC fiber sheet that semi-cured PVS was integrated with SiC filaments.

14 of the impregnated SiC fiber sheets were laminated to a SiC fiber preform of 2 mm in thickness. The SiC fiber preform was inserted in a carbon mold, heated up to 1200° C. at a heating rate of 300° C./h in an argon atmosphere in an oven equipped with a carbon heater under application of a unidirectional pressure of 10 MPa along a perpendicular direction, held at 1200° C. for 10 minutes and then cooled in a pressure-released state over 2 hours or longer. A product was SiC fiber-reinforced SiC composite with porosity of 31%.

The fiber-reinforced SiC composite was further impregnated with PVS in vacuum and pyrolyzed without a pressure at a temperature of 1200° C. or lower. The impregnation and the pressure-less pyrolysis were alternately repeated 6 times. Fiber-reinforced SiC composite subjected to the repetition of impregnation and pressure-less pyrolysis had flexural strength of 375 MPa in average and fracture work of 2.1 kJ/m² with porosity reduced to 15%.

### Example 4

Polymeric slurry was prepared by dispersing β-SiC particles of 0.27 μm in average size in PVS at a ratio of 57 mass % and stirring the suspension in an open atmosphere. Plain-woven cloth of SiC fiber cut out to 40 mm in length and 40 mm in width was dipped in the polymeric slurry in an open atmosphere, so as to fill openings between SiC filaments with the polymeric slurry.

10 of SiC fiber sheets impregnated with the polymeric slurry were laminated to a polymer-impregnated SiC fiber preform of 3 mm in thickness. The polymer-impregnated SiC fiber preform was sealed in a carbon receptacle, heated up to 330° C. at a heating rate of 300° C./h in an argon atmosphere, held at 330° C. for 10 minutes, and then gradually cooled down to an ambient temperature over 1 hour or longer. It was noted by observation of the preheat-treated SiC fiber preform that the semi-cured polymeric slurry infiltrated into openings between SiC filaments.

The preheat-treated SiC fiber preform was inserted in a carbon mold for pressurized pyrolysis, and located in an oven equipped with a carbon heater. Thereafter, the SiC fiber preform was heated up to 1200° C. at a heating rate of 300° C./h in an argon atmosphere under application of a unidirectional pressure of 5 MPa along its perpendicular direction, held at 1200° C. for 10 minutes and cooled down in a pressure-free state over 2 hours. A product was SiC fiber-reinforced SiC-matrix composite with bulk density of 2.0 g/m³.

The SiC composite was further impregnated with sole PVS in vacuum and pyrolyzed without a pressure at 1200° C. The impregnation with sole PVS and the pressure-less pyrolysis were alternately repeated 8 times. The SiC composite was densified to bulk density of 2.4 g/cm³ by repetition of the impregnation and the pressure-less pyrolysis. The SiC composite had flexural strength of 281 MPa in average and fracture work of 1.489 kJ/m², and its fracture mode was nonlinear.

### Example 5

Polymeric slurry was prepared by dispersing β-SiC particles of 0.3 μm in average size to PVS at a ratio of 57 mass %. Continuous SiC filaments of 14 μm in diameter were unidirectionally aligned to a SiC fiber sheet. After the SiC fiber sheet was sized to 40 mm in length and 20 mm in width, the polymeric slurry was dropped on the SiC fiber sheet to produce a polymer-impregnated SiC fiber sheet.

The polymer-impregnated SiC fiber sheet was preheat-treated up to 330° C. at a heating rate of 300° C./h in an argon atmosphere, held at 330° C. for 10 minutes and cooled down to an ambient temperature over 1 hour or longer. It was noted by observation of the preheat-treated SiC fiber composite that PVS was semi-cured and integrated with the SiC sheet.

14 of the polymer-SiC fiber composite sheets were laminated to a preform of 2 mm in thickness. The preform was put in a carbon mold and located in an oven equipped with a carbon heater. The preform was heated up to 1200° C. at a heating rate of 300° C./h under application of a unidirectional pressure of 5 MPa along its perpendicular direction in an argon atmosphere, held at 1200° C. for 10 minutes and then cooled down in a pressure-released state over 2 hours. A product was SiC fiber-reinforced SiC-matrix composite with porosity of 31%.

The SiC composite was further impregnated with sole PVS and pyrolyzed without a pressure at 1200° C. Impregnation with sole PVS and pressure-less pyrolysis were alternately repeated 6 times. Porosity of the SiC composite was reduced to 3% by repetition of the impregnation with sole PVS and pressure-less pyrolysis. The densified SiC composite had flexural strength of 602 MPa and fracture work of 5.1 kJ/m². The value of fracture work was three times high as compared with SiC composite (1.72 kJ/m²) made from a SiC fiber preform impregnated with polymeric slurry dispersing β-SiC particles therein at a ratio of 25 mass % under the same conditions.

### EXAMPLE 6

Polymeric slurry was prepared by dispersing β-SiC particles of 0.3 μm in average size to PVS at a ratio of 67 mass %. Continuous SiC filaments of 14 μm in average diameter were unidirectionally aligned to a SiC fiber sheet. After the SiC fiber sheet was sized to 40 mm in length and 20 mm in width, the polymeric slurry was dropped on the SiC fiber sheet in an open atmosphere, to produce a polymer-impregnated SiC fiber sheet.

The polymer-impregnated SiC fiber sheet was heated up to 330° C. at a heating rate of 300° C./h in an argon atmosphere, held at 330° C. for 10 minutes and then cooled down to an ambient temperature over 1 hour or longer. It was noted by observation of the cooled SiC fiber sheet that PVS was semi-cured and integrated with SiC filaments.

14 of the polymer-SiC fiber composite sheets were laminated to a preform of 2 mm in thickness. The preform was put in a carbon mold and located in an oven equipped with a carbon heater. The polymer-SiC fiber preform was heated up to 1200° C. at a heating rate of 300° C./h in an argon atmosphere under application of a unidirectional pressure of 5 MPa along its perpendicular direction, held at 1200° C. for 10 minutes and then cooled down in a pressure-released state over 2 hours or longer. A product was SiC fiber-reinforced SiC-matrix composite with porosity of 33%.

The SiC composite was further impregnated with sole PVS in vacuum and pyrolyzed without a pressure at 1200° C. The impregnation with sole PVS and the pressure-less pyrolysis were alternately repeated 6 times. Porosity of the SiC composite was reduced to 5% by repetition of the impregnation with sole PVS and the pressure-less pyrolysis. The densified SiC composite had flexural strength of 575 MPa in average and fracture work of 4.3 kJ/m². The value of fracture work was 2.5 times high as compared with SiC composite (1.72 kJ/m²) made from a SiC fiber preform impregnated with polymeric slurry dispersing β-SiC particles therein at a ratio of 25 mass %.

Results of Examples 1 to 6 prove that SiC fiber-reinforced SiC-matrix composite excellent in flexural strength and fracture work can be produced by combination of pre-curing PVS under properly controlled conditions with pyrolysis under application of a unidirectional pressure. The SiC composite is further densified by dispersion of fine SiC particles in PVS slurry for impregnation of a SiC fiber preform.

According to the present invention as above-mentioned, thermosetting PVS is used as a SiC precursor for impregnation of a SiC fiber preform to produce SiC fiber-reinforced SiC-matrix composite. After the SiC fiber preform is impregnated with PVS, PVS is moderated to a viscous or semi-cured state by preheat-treatment in prior to pressurized pyrolysis. The viscous or semi-cured PVS is not extruded out of the SiC fiber preform even under application of a pressure during pyrolysis.

PVS is a compound, which is ceramized at a high yield ratio, among various liquid polymers. It is fluid enough for infiltration into openings between SiC filaments at an ambient temperature, and moderated to a viscous or semi-cured state appropriate for inhibition of extrusion from a SiC fiber preform by preheat-treatment. Consequently, SiC fiber-reinforced SiC-matrix composite of dense structure with high SiC purity is produced by pressurized pyrolysis in an argon atmosphere without use of special equipment such as an electron beam-irradiating device. PVS slurry is also kept at proper viscosity enough for infiltration into openings of SiC filaments, even when fine SiC particles are suspended therein in order to reduce volumetric shrinkage of PVS during pyrolysis.

The SiC fiber-reinforced SiC-matrix composite produced in this way is useful as structural members for nuclear power plants, nuclear fusion reactors, aircraft, spacecraft or the like driven under severe conditions or exposed to a severe environment due to its excellent mechanical strength and high-temperature property.

1. SiC fiber-reinforced SiC-matrix composite, which has the structure that SiC filaments are inserted into SiC-matrix formed as a pyrolysis product of polyvinyl-silane infiltrating into openings of said SiC filaments.

2. The SiC fiber-reinforced SiC-matrix composite defined by claim 1, wherein the polyvinyl-silane has structural units represented by the under-mentioned formulas (a) and (b) at an a/b ratio of 1;
(a)
—SiH₂—CH₂—CH₂—

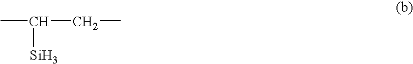

3. A method of manufacturing SiC fiber-reinforced SiC-matrix composite, which comprises the steps of:
impregnating a SiC fiber preform with polymeric slurry of polyvinyl-silane having structural units represented by the under-mentioned formulas (a) and (b) at an a/b ratio of 1; and
pyrolyzing the impregnated SiC fiber preform at 1000-1300° C. in an argon atmosphere.
(a)
—SiH₂—CH₂—CH₂—

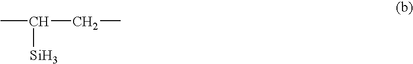

4. The manufacturing method defined by claim 3, wherein the SiC fiber preform impregnated with the polymeric slurry is preheat-treated at 300-400° C. so as to moderate the polyvinyl-silane to a viscous or semi-cured state.

5. The manufacturing method defined by claim 3, wherein the SiC fiber preform impregnated with the polymeric slurry is pyrolyzed at 1000-1300° C. under application of a unidirectional pressure.

6. The manufacturing method defined by claim 3, wherein the polymeric slurry of polyvinyl-silane disperses fine SiC particles therein.

7. The manufacturing method defined by claim 3, wherein the SiC fiber-reinforced SiC-matrix composite is further subjected to alternate repetition of impregnation with sole polyvinyl-silane and pressure-less pyrolysis.
